(19) United States
(12) Patent Application Publication
(10) Pub. No.: US 2011/0238854 A1
(43) Pub. Date: Sep. 29, 2011

(54) STREAMING DATA RELAY APPARATUS AND RELATED WIRELESS GATEWAY APPARATUS

(76) Inventors: Tsan-Sen FANG, Hsinchu City (TW); Tsung-Yi SHIEN, Hukou (TW); Chung-Chiu LAI, Zheubei City (TW)

(21) Appl. No.: 12/813,045

(22) Filed: Jun. 10, 2010

(30) Foreign Application Priority Data
Mar. 29, 2010 (TW) 099109315

(51) Int. Cl. G06F 15/16

(52) U.S. Cl. 709/231

(57) ABSTRACT

A streaming data relay apparatus is disclosed including: an RF module for receiving streaming data transmitted in unicast format from a wireless gateway apparatus; an Ethernet connection module; and a control unit for transmitting the streaming data in unicast format to multiple client devices corresponding to a same multicast group via the Ethernet connection module; wherein when a first client device out of the multiple client devices requests to leave the multicast group, the control unit transmits the physical address of the first client device to the wireless gateway apparatus through wireless transmission via the RF module.

### BACKGROUND OF THE INVENTION

1. Field of the Invention

The present invention relates to technology for providing multimedia streaming services, and more particularly, to streaming data relay apparatuses and related wireless gateway apparatuses capable of improving quality of multimedia streaming service.

2. Description of Related Art

Multimedia streaming service has become more and more popular as the Internet accessing bandwidth increases. When a user applies for a multimedia streaming service, the multimedia streaming service provider would provide the user with a dedicated set-top box to receive the content of multimedia streaming service. In many applications, the multimedia streaming service provider transmits the content of multimedia streaming service in multicast format.

Traditionally, the set-top box provided by the multimedia streaming service provider requires connecting to a gateway apparatus via physical cable so as to access the Internet. The use of the physical cable is usually troublesome and causes inconvenient in wiring or interior decoration. In addition, some users may utilize a wireless AP as the gateway apparatus for other networking devices. Thus, some multimedia streaming service providers or users may install a wireless transceiver on the Ethernet communication interface of the set-top box, so that the set-top box is able to communicate with the wireless AP via the wireless transceiver, thereby providing more flexibility in arranging the location of the set-top box.

In general wireless transmission environments, however, packet loss easily occurs when the multimedia streaming data is transmitted in multicast format, thereby deteriorating the quality of multimedia streaming service and causing customer complaints.

### SUMMARY OF THE INVENTION

In view of the foregoing, it can be appreciated that a substantial need exists for methods and apparatuses that can mitigate or reduce the problems in providing multimedia streaming service.

An exemplary embodiment of a streaming data relay apparatus is disclosed comprising: an RF module for receiving streaming data transmitted in unicast format from a wireless gateway apparatus; an Ethernet connection module; and a control unit for transmitting the streaming data in unicast format to multiple client devices corresponding to a same multicast group via the Ethernet connection module; wherein when a first client device out of the multiple client devices requests to leave the multicast group, the control unit transmits a physical address of the first client device to the wireless gateway apparatus through wireless transmission via the RF module.

An exemplary embodiment of a wireless gateway apparatus is disclosed comprising: a communication interface for receiving streaming data transmitted in multicast format and addressed to a multicast group; an RF module; and a processor for transmitting the streaming data in unicast format to a streaming data relay apparatus coupled with multiple client devices corresponding to the multicast group via the RF module; wherein when a first client device out of the multiple client devices requests to leave the multicast group, the processor continues transmitting the streaming data addressed to the multicast group in unicast format to the streaming data relay apparatus via the RF module as long as at least one of the multiple client devices is still in the multicast group.

An exemplary embodiment of a streaming data transmission device is disclosed comprising: a wireless gateway apparatus for receiving streaming data transmitted in multicast format and addressed to a multicast group, and transmitting the streaming data in unicast format through wireless transmission; a streaming data relay apparatus for transmitting received streaming data to coupled multiple client devices, and transmitting a physical address of a first client device out of the multiple client devices to the wireless gateway apparatus through wireless transmission when the first client device requests to leave the multicast group; wherein the wireless gateway apparatus continues transmitting the streaming data addressed to the multicast group in unicast format to the streaming data relay apparatus as long as at least one of the multiple client devices is still in the multicast group.

It is to be understood that both the foregoing general description and the following detailed description are exemplary and explanatory only and are not restrictive of the invention, as claimed.

### BRIEF DESCRIPTION OF THE DRAWINGS

FIG. 1 is a simplified block diagram of a multimedia streaming data transmission device in accordance with an exemplary embodiment.

FIG. 2 is a simplified functional block diagram of the streaming data relay apparatus of FIG. 1 according to an exemplary embodiment.

FIG. 3 is a simplified functional block diagram of the wireless gateway apparatus of FIG. 1 according to an exemplary embodiment.

### DETAILED DESCRIPTION

The same reference numbers may be used throughout the drawings to refer to the same or like parts or operations. Certain terms are used throughout the description and following claims to refer to particular components. As one skilled in the art will appreciate, vendors may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”

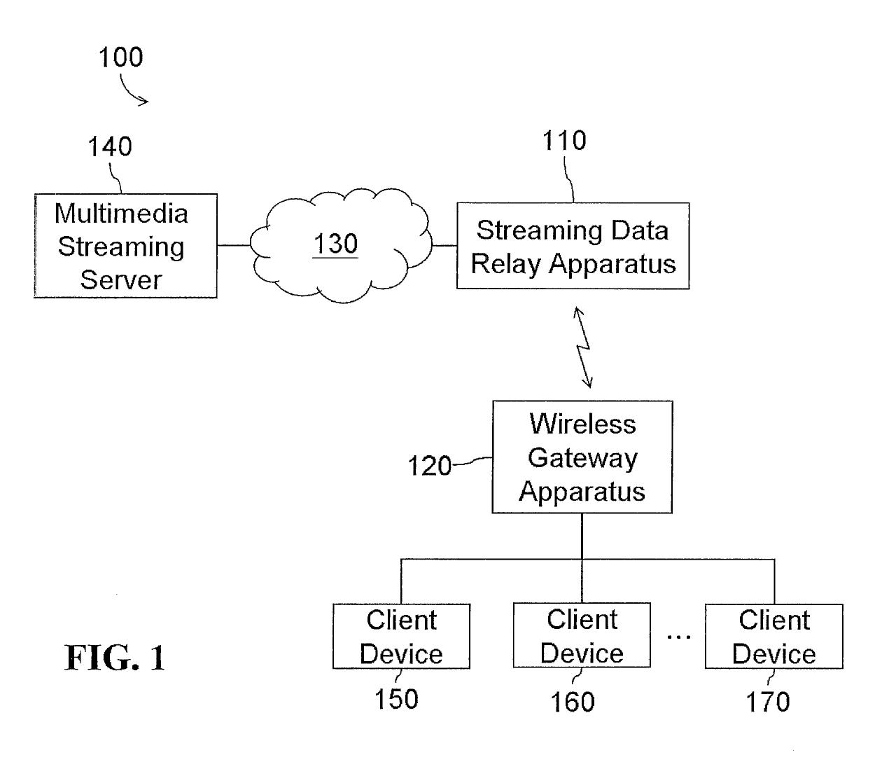

Please refer to FIG. 1, which shows a simplified block diagram of a multimedia streaming data transmission device 100 in accordance with an exemplary embodiment. The multimedia streaming data transmission device 100 comprises a streaming data relay apparatus 110 and a wireless gateway apparatus 120. The streaming data relay apparatus 110 may be coupled with multiple client devices (client devices 150, 160, and 170 are shown in FIG. 1 as examples), such as set-top boxes. The phrase “coupled with” as used herein is intended to compass any indirect or direct connection. In other words, the streaming data relay apparatus 110 may be directly connected to the client devices (including through an electrical connection or other signal connections, such as wireless communications or optical communications), or indirectly connected to the client devices through an indirect electrical connection or signal connection via other intermediate device or connection means. The wireless gateway apparatus 120 cornmunicates with a multimedia streaming server 140 of a multimedia streaming service provider (such as an Internet Service Provider or cable TV vendor) via the Internet 130 to access related multimedia streaming service.

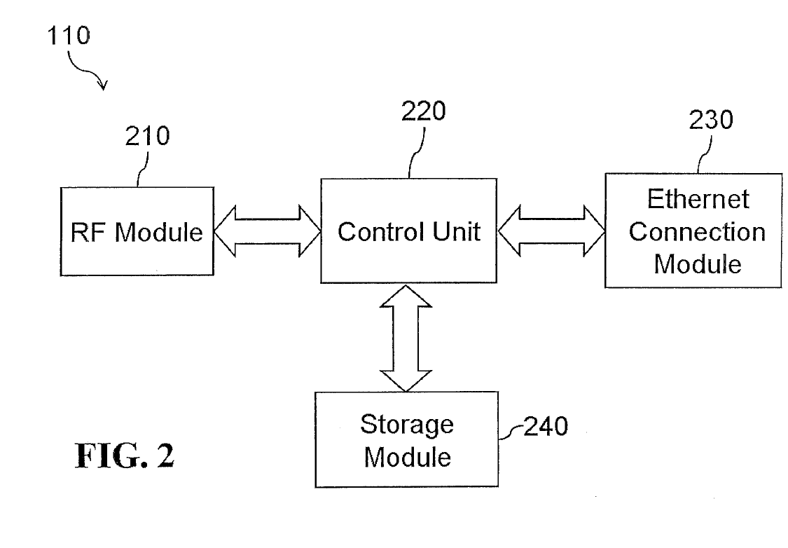

FIG. 2 shows a simplified functional block diagram of the streaming data relay apparatus 110 according to an exemplary embodiment. In this embodiment, the streaming data relay apparatus 110 comprises an RF module 210, a control unit 220, an Ethernet connection module 230, and a storage module 240. The storage module 240 stores the mapping information of the physical address (such as MAC address) and physical communication port used for each coupled client device.

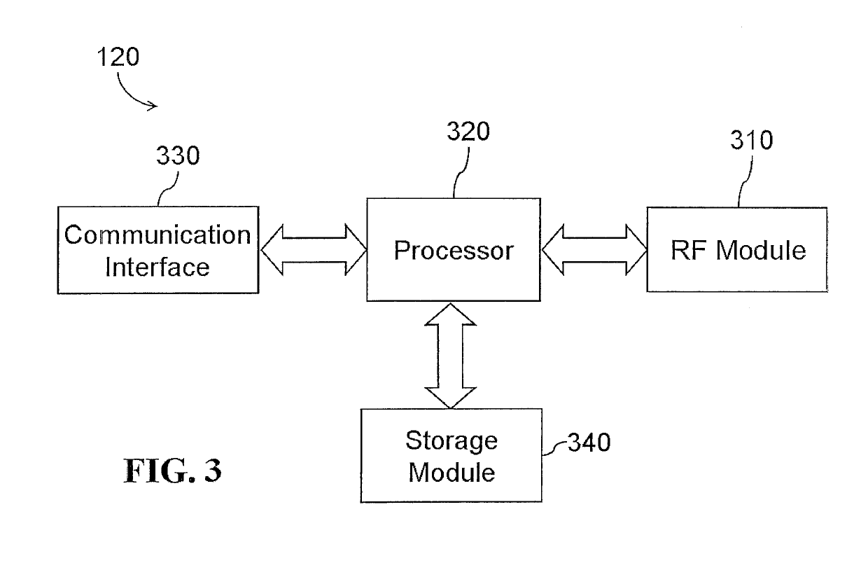

FIG. 3 shows a simplified functional block diagram of the wireless gateway apparatus 120 according to an exemplary embodiment. The wireless gateway apparatus 120 of this embodiment comprises an RF module 310, a processor 320, a communication interface 330, and a storage module 340.

The operations of the multimedia streaming data transmission device 100 will be further described below

Once any client device would like to join a specific multicast group to receive specific multimedia streaming content, the client device may generate a membership report message according to a general multicast group membership communication protocol, and transmit the membership report message using Ethernet packets to the streaming data relay apparatus 110. The above-mentioned multicast group membership communication protocol may be Internet Group Management Protocol (IGMP), Multicast Listener Discovery (MLD), or other communication protocol.

For example, when the client device 150 would like to join a multicast group GROUP_1 to receive specific multimedia streaming content, the client device 150 may generate a multicast group membership report message MR_150 and transmit the multicast group membership report message MR_150 using Ethernet packets to the streaming data relay apparatus 110.

When the Ethernet connection module 230 of the streaming data relay apparatus 110 receives the multicast group membership report message MR_150 transmitted from the client device 150, the control unit 220 of the streaming data relay apparatus 110 transmits the message indicating that the client device 150 requested to join the multicast group GROUP_1 and a physical address PHY_150 of the client device 150 to the wireless gateway apparatus 120 through wireless transmission via the RF module 210.

In one embodiment, the control unit 220 adds the physical address PHY_150 of the client device 150 into the multicast group membership report message MR_150 to generate a modified multicast group membership report message MR_150′. Afterward, the control unit 220 transmits the modified multicast group membership report message MR_150′ to the wireless gateway apparatus 120 through wireless transmission via the RF module 210. In implementations, the control unit 220 may record the physical address PHY_150 of the client device 150 into the reserved fields or other available fields of the modified multicast group membership report message MR_150′ (such as the fields in the end of the modified multicast group membership report message MR_150′), and stores an indication mark in a revered field or other available fields to indicate that the modified multicast group membership report message MR_150′ contains the physical address of a specific client device (e.g., the client device 150 in this case).

When the RF module 310 of the wireless gateway apparatus 120 receives the modified multicast group membership report message MR_150′, the processor 320 of the wireless gateway apparatus 120 obtains a physical address PHY_110 of the streaming data relay apparatus 110. In this embodiment, the processor 320 reads the indication mark stored in the modified multicast group membership report message MR_150′ and would learn that the modified multicast group membership report message MR_150′ also contains the physical address of a client device (e.g., the client device 150 in this case). Accordingly, the processor 320 knows that the client device 150 would like to join the multicast group GROUP_1. The processor 320 records the mapping information of the physical address PHY_150 of the client device 150 and the multicast group GROUP_1 in the storage module 340.

In another embodiment, the control unit 220 transmits the multicast group membership report message MR_150 to the wireless gateway apparatus 120 through wireless transmission via the RF module 210. In addition, the control unit 220 further stores the physical address PHY_150 of the client device 150 and an indication mark in an action management frame F_JOIN complying with the Ethernet communication protocol, and transmits the action management frame F_JOIN to the wireless gateway apparatus 120 through wireless transmission via the RF module 210. In this embodiment, the indication mark is used for indicating that the client device 150 corresponding to the physical address PHY_150 would like to join the multicast group GROUP_1.

Similarly, when the RF module 310 of the wireless gateway apparatus 120 receives the multicast group membership report message MR_150 transmitted from the streaming data relay apparatus 110, the processor 320 of the wireless gateway apparatus 120 obtains the physical address PHY_110 of the streaming data relay apparatus 110. In addition, when the RF module 310 receives the action management frame F_JOIN, the processor 320 would learn the physical address of a client device (e.g., client device 150 in this case) from the content of the action management frame F_JOIN, and would learn from the indication mark stored in the action management frame F_JOIN that the client device 150 would like to join the multicast group GROUP_1. The processor 320 records the mapping information of the physical address PHY_150 of the client device 150 and the multicast group GROUP_1 in the storage module 340.

With the foregoing methods, the processor 320 of the wireless gateway apparatus 120 is able to obtain the mapping information of a client device and the multicast group the client device has joined through the assistance of the streaming data relay apparatus 110. For illustrative purpose, it is assumed hereafter that the client device 150 has joined the multicast group GROUP_1, and the client devices 160 and 170 have joined a multicast group GROUP_2.

When the communication interface 330 of the wireless gateway apparatus 120 receives a streaming data STREAM_1 transmitted in multicast format from the multimedia streaming server 140 and addressed to the multicast group GROUP_1, the processor 320 transmits the streaming data STREAM_1 in unicast format to the streaming data relay apparatus 110 via the RF module 310. When the RF module 210 of the streaming data relay apparatus 110 receives the streaming data STREAM_1, the control unit 220 inquiries the mapping information of the physical address of the client devices and the physical communication port used stored in the storage module 240, and transmits the streaming data STREAM_1 in unicast format to the client device 150 corresponding to the multicast group GROUP_1 via the Ethernet connection module 230.

When the wireless gateway apparatus 120 receives a streaming data STREAM_2 transmitted in multicast format from the multimedia streaming server 140 and addressed to the multicast group GROUP_2, the processor 320 transmits the streaming data STREAM_2 in unicast format to the streaming data relay apparatus 110 via the RF module 310. When the RF module 210 of the streaming data relay apparatus 110 receives the streaming data STREAM_2, the control unit 220 transmits the streaming data STREAM_2 in unicast format to the client devices 160 and 170 corresponding to the multicast group GROUP_2 via the Ethernet connection module 230.

As can be seen from the foregoing descriptions, the streaming data relay apparatus 110 is capable of wirelessly receiving streaming data transmitted from the wireless gateway apparatus 120. Therefore, the user has more flexibility in arranging the location of the wireless gateway apparatus 120, and needs not to worry about the wiring between the client devices and the wireless gateway apparatus 120.

In addition, the wireless gateway apparatus 120 converts the streaming data in multicast format transmitted from the multimedia streaming server 140 into unicast format and then transmits to the streaming data relay apparatus 110. Since the unicast transmission has re-transmission mechanism to reduce the problem of packet loss, the quality of multimedia streaming service can be greatly improved.

Once any client device would like to leave a specific multicast group, the client device may generate a leave group message according to the above-mentioned multicast group membership communication protocol, and transmit the leave group message to the streaming data relay apparatus 110 using the Ethernet packets.

For example, when the client device 160 would like to leave the multicast group GROUP_2, the client device 160 may generate a leave group message LG_160, and transmit the leave group message LG_160 to the streaming data relay apparatus 110 using the Ethernet packets.

When the Ethernet connection module 230 receives the leave group message LG_160 from the client device 160, the control unit 220 of the streaming data relay apparatus 110 transmits the message that the client device 160 requested to leave the multicast group GROUP_2 and the physical address PHY_160 of the client device 160 to the wireless gateway apparatus 120 through wireless transmission via the RF module 210.

In one embodiment, the control unit 220 adds the physical address PHY_160 of the client device 160 into the leave group message LG_160 to generate a modified leave group message LG_160′. Afterward, the control unit 220 transmits the modified leave group message LG_160′ to the wireless gateway apparatus 120 through wireless transmission via the RF module 210. In implementations, the control unit 220 may record the physical address PHY_160 of the client device 160 into the reserved fields or other available fields of the modified leave group message LG_160′ (such as the fields in the end of the modified leave group message LG_160′), and stores an indication mark in a revered field or other available fields to indicate that the modified leave group message LG_160′ contains the physical address of a specific client device (e.g., the client device 160 in this case).

When the RF module 310 of the wireless gateway apparatus 120 receives the modified leave group message LG_160′, the processor 320 obtains the physical address PHY_110 of the streaming data relay apparatus 110. In addition, the processor 320 further reads the indication mark stored in the modified leave group message LG_160′ and would learn that the modified leave group message LG_160′ also contains the physical address of a client device (e.g., the client device 160 in this case). Accordingly, the processor 320 knows that the client device 160 would like to leave the multicast group GROUP_2. The processor 320 deletes the mapping information of the physical address PHY_160 of the client device 160 and the multicast group GROUP_6 from the storage module 340.

In another embodiment, the control unit 220 transmits the leave group message LG_160 to the wireless gateway apparatus 120 through wireless transmission via the RF module 210. In addition, the control unit 220 further stores the physical address PHY_160 of the client device 160 and an indication mark in an action management frame F_LEAVE complying with the Ethernet communication protocol, and transmits the action management frame F_LEAVE to the wireless gateway apparatus 120 through wireless transmission via the RF module 210. In this embodiment, the indication mark is used for indicating that the client device 160 corresponding to the physical address PHY_160 would like to leave the multicast group GROUP_2.

Similarly, when the RF module 310 of the wireless gateway apparatus 120 receives the leave group message LG_160 transmitted from the streaming data relay apparatus 110, the processor 320 of the wireless gateway apparatus 120 obtains the physical address PHY_110 of the streaming data relay apparatus 110. In addition, when the RF module 310 receives the action management frame F_LEAVE, the processor 320 would learn the physical address of a client device (e.g., client device 160 in this case) from the content of the action management frame F_LEAVE, and would learn from the indication mark stored in the action management frame F_LEAVE that the client device 160 would like to leave the multicast group GROUP_2. The processor 320 deletes the mapping information of the physical address PHY_160 of the client device 160 and the multicast group GROUP_6 from the storage module 340.

However, the processor 320 of the wireless gateway apparatus 120 would check the mapping information of respective client device and corresponding multicast group stored in the storage module 340, and learn that the client device 170 has not left the multicast group GROUP_2 yet. Thus, the processor 320 continues transmitting the streaming data STREAM_2 transmitted in multicast format from the multimedia streaming server 140 and addressed to the multicast group GROUP_2 to the streaming data relay apparatus 110 in unicast format via the RF module 310. When the RF module 210 of the streaming data relay apparatus 110 receives the streaming data STREAM_2, the control unit 220 transmits the streaming data STREAM_2 in unicast format to the client device 170 corresponding to the multicast group GROUP_2 via the Ethernet connection module 230.

Once the wireless gateway apparatus 120 receives a message that a specific client device requested to leave a specific multicast group, the processor 320 of the wireless gateway apparatus 120 checks the mapping information of respective client device and corresponding multicast group stored in the storage module 340 to determine whether any client device coupled with the streaming data relay apparatus 110 has not left the specific multicast group. As long as there is at least one client device (e.g., the client device 170) coupled with the streaming data relay apparatus 110 not leave the specific multicast group, the processor 320 continues transmitting streaming data addressed to the specific multicast group in unicast format to the streaming data relay apparatus 110.

On the contrary, if all client devices that previously joined the specific multicast group have left the specific multicast group, the processor 320 stops transmitting streaming data addressed to the specific multicast group to the streaming data relay apparatus 110.

It can be appreciated from the foregoing descriptions that when partial client devices out of multiple client devices that joined the same multicast group leave the multicast group, the operations of transmitting streaming data addressed to the multicast group to the streaming data relay apparatus 110 in unicast format made by the wireless gateway apparatus 120 are not affected. Accordingly, the multimedia streaming service received by other client devices that have not left the multicast group will not be interrupted.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A streaming data relay apparatus comprising:
an RF module for receiving streaming data transmitted in unicast format from a wireless gateway apparatus;
an Ethernet connection module; and
a control unit for transmitting the streaming data in unicast format to multiple client devices corresponding to a same multicast group via the Ethernet connection module;
wherein when a first client device out of the multiple client devices requests to leave the multicast group, the control unit transmits a physical address of the first client device to the wireless gateway apparatus through wireless transmission via the RF module.

2. The streaming data relay apparatus of claim 1, wherein the control unit records the physical address of the first client device in a leave group message, and transmits the leave group message to the wireless gateway apparatus through wireless transmission via the RF module.

3. The streaming data relay apparatus of claim 2, wherein the physical address of the first client device is appended to the end of the leave group message.

4. The streaming data relay apparatus of claim 1, wherein the control unit records the physical address of the first client device in an action management frame complying with the Ethernet communication protocol, and transmits the action management frame to the wireless gateway apparatus through wireless transmission via the RF module.

5. The streaming data relay apparatus of claim 1, wherein when the first client device requests to join the multicast group, the control unit records the physical address of the first client device in a membership report message, and transmits the membership report message to the wireless gateway apparatus through wireless transmission via the RF module.

6. The streaming data relay apparatus of claim 1, wherein when the first client device requests to join the multicast group, the control unit records the physical address of the first client device in an action management frame complying with the Ethernet communication protocol, and transmits the action management frame to the wireless gateway apparatus through wireless transmission via the RF module.

7. A wireless gateway apparatus comprising:
a communication interface for receiving streaming data transmitted in multicast format and addressed to a multicast group;
an RF module; and
a processor for transmitting the streaming data in unicast format to a streaming data relay apparatus coupled with multiple client devices corresponding to the multicast group via the RF module;
wherein when a first client device out of the multiple client devices requests to leave the multicast group, the processor continues transmitting the streaming data addressed to the multicast group in unicast format to the streaming data relay apparatus via the RF module as long as at least one of the multiple client devices is still in the multicast group.

8. The wireless gateway apparatus of claim 7, wherein the processor stop transmitting the streaming data addressed to the multicast group to the streaming data relay apparatus if all of the multiple client devices left the multicast group.

9. The wireless gateway apparatus of claim 7, wherein the RF module receives an action management frame transmitted from the streaming data relay apparatus, wherein the action management frame contains a physical address of the first client device and complies with the Ethernet communication protocol.

10. The wireless gateway apparatus of claim 7, wherein the RF module receives a leave group message transmitted from the streaming data relay apparatus, wherein the leave group message contains a physical address of the first client device.

11. The wireless gateway apparatus of claim 10, wherein the physical address of the first client device is appended to the end of the leave group message.

12. The wireless gateway apparatus of claim 7, wherein when the first client device requests to join the multicast group, the RF module receives a membership report message transmitted from the streaming data relay apparatus, wherein the membership report message contains a physical address of the first client device.

13. The wireless gateway apparatus of claim 7, wherein when the first client device requests to join the multicast group, the RF module receives an action management frame transmitted from the streaming data relay apparatus, wherein the action management frame contains a physical address of the first client device and complies with the Ethernet communication protocol.

14. A streaming data transmission device comprising:
a wireless gateway apparatus for receiving streaming data transmitted in multicast format and addressed to a multicast group, and transmitting the streaming data in unicast format through wireless transmission;
a streaming data relay apparatus for transmitting received streaming data to coupled multiple client devices, and transmitting a physical address of a first client device out of the multiple client devices to the wireless gateway apparatus through wireless transmission when the first client device requests to leave the multicast group;
wherein the wireless gateway apparatus continues transmitting the streaming data addressed to the multicast group in unicast format to the streaming data relay apparatus as long as at least one of the multiple client devices has not left the multicast group yet.

15. The streaming data transmission device of claim 14, wherein when the first client device requests to leave the multicast group, the streaming data relay apparatus records the physical address of the first client device in a leave group message and transmits the leave group message to the wireless gateway apparatus through wireless transmission.

16. The streaming data transmission device of claim 15, wherein the physical address of the first client device is appended to the end of the leave group message.

17. The streaming data transmission device of claim 14, wherein when the first client device requests to leave the multicast group, the streaming data relay apparatus records the physical address of the first client device in an action management frame complying with the Ethernet communication protocol, and transmits the action management frame to the wireless gateway apparatus through wireless transmission.

18. The streaming data transmission device of claim 14, wherein when the first client device requests to join the multicast group, the streaming data relay apparatus records the physical address of the first client device in a membership report message, and transmits the membership report message to the wireless gateway apparatus through wireless transmission.

19. The streaming data transmission device of claim 14, wherein when the first client device requests to join the multicast group, the streaming data relay apparatus records the physical address of the first client device in an action management frame complying with the Ethernet communication protocol, and transmits the action management frame to the wireless gateway apparatus through wireless transmission.

20. The streaming data transmission device of claim 14, wherein the wireless gateway apparatus stores the physical address of each client device transmitted from the streaming data relay apparatus and accordingly determines whether there is any client device still in the multicast group.
